(19) United States
(12) Patent Application Publication
(10) Pub. No.: US 2026/0091855 A1
(43) Pub. Date: Apr. 2, 2026

(54) POWER GENERATOR FOR GENERATING POWER FROM WATER FLOW

(71) Applicant: SEALEC LTD, London (GB)

(72) Inventors: Robert GRAY, Fawley (GB); Graham BAILEY, Cowes (GB)

(21) Appl. No.: 19/110,173

(22) PCT Filed: Sep. 12, 2023
(86) PCT No.: PCT/GB2023/052349

§ 371 Date: Mar. 10, 2025

(30) Foreign Application Priority Data
Sep. 12, 2022 (GB) 2213298.9

(51) Int. Cl. B63B 35/44; F03B 13/26

(52) U.S. Cl. CPC B63B 35/44; F03B 13/266; B63B 2035/4466; F05B 2220/706

(57) ABSTRACT

A power generator for generating power from a water flow. The generator has a single blade (1) rotatable through a limited arc about a sweep axis (13) and rotatable through a limited arc about a pitch axis (6) extending along a mid-portion of the blade such the blade is overbalanced. The blade is retainable in two rotary positions in which opposite faces (4) face the flow, It is pushed by the flow in about the sweep axis and is configured to tack about the pitch axis to an opposite rotary position. Passive tacking stops (26) arrest the momentum of the leading edge of the blade and cause the blade to tack. The generator is preferably mounted to extend downwardly from a surface vessel (80).

The present invention relates to a power generator for generating power from a water flow.

In principle, the device can generate power from any water flow. However, it is particularly designed to be a tidal power generator.

Various types of tidal flow device are known in the art. These are generally based on turbine blades which are mounted to rotate about a horizontal or vertical axis. Other types of tidal generator include oscillating hydrofoils, Archimedes screws and tidal kites.

For the most part, tidal generators are designed for use in areas of very high tidal flow and thus high power density theoretically to be harvested. These projects are expensive and present very significant installation, maintenance and engineering challenges. The subsea environment in high tidal flow locations can be rocky, seabed conditions can be harsh and weather conditions and high tidal flows themselves often mean that there is short window of time for carrying out the installation and maintenance. Electric cables are also hard to install and protect in a hostile subsea environment.

The present invention takes a fundamentally different approach both in its technology and range of potential locations. The aim of the present invention is to provide simple devices which can readily be scalable and which can be installed and operate in more benign locations and at lower current speeds thereby reducing infrastructure, maintenance and installation problems.

A number of prior art documents FR3049988, CN105257457, US2015/0014996, US2009/0218822, US2018/0328337 and FR3037621 disclose generators which use a blade which sweeps about a horizontal axis and pitches about a vertical axis. For various reasons such as blade geometry and complexity, as far as we are aware, none of these proposals has become a commercial product.

According to the present invention, there is provided a power generator according to claim 1.

This design is very simple requiring a single blade which is mounted to rotate about two axes. The blade sweeps from side to side about the sweep axis by virtue of water current pressure against the entire blade surface which is overbalanced. An overbalanced blade (i.e. where more than 50% of the area of the blade is ahead/upstream of the sweep axis) means the blade is inherently held open by the flow (i.e. the front part of the blade will be pushed away from a neutral position to the first or second rotary position). As such when placed in a flow of water, it will inevitably be pushed by the flow about the vertical axis.

By contrast, in FR3049988, the blade is strongly underbalanced, such that the flow will tend to push the blade towards a neutral position in which it will simply stop moving. This arrangement would therefore require an energy input in order to create oscillation or function at all.

At the end of the sweep, the blade automatically tacks with no secondary actuation input and sweeps back in the opposite direction again with the tidal pressure on the full face of the blade. This is achieved by the tacking stops arresting the leading edge of the sweeping blade towards the end of its sweep such that the remainder of the blade behind the arrested leading edge continues to sweep under its momentum until the water flow impacts the other side of the blade and its greater surface area causes the blade to tack and re-orientate around the sweep axis to the designed angle for the return reciprocal sweep.

The energy needed to tack the blade is minimal as the blade is over balanced and is very low compared to the power generated by the sweeping of the blade itself. The blade is able to operate at relatively low tidal flow velocities compared to a conventional rotating turbine such that it is also less damaging to marine life and less susceptible to impact damage than a conventional rotating turbine.

The tacking is done automatically with a simple passive mechanism which does not require a complex power supply such as that shown in CN105257457 or a complex and inefficient flywheel such as that used in US 2018/0328337.

The blades can be simple in construction and have no intrinsic scale limitations and can be made in all sizes up to large scale depending upon location and water depth.

Preferably each passive tacking stop is positioned to engage with part of the blade which is closer to the most forward part of leading edge than it is to the pitch axis. In particluar, the stops engage as close as possible to the leading edge. As the blade effectively pivots around the stop when tacking, the advanced position of the stop ensures that that the continuing sweep of the blade behind the arrested leading edge of the blade (effectively a new axis) causes the blade to expose its reverse side to the flow thereby allowing the overbalance of the front part of the blade to effect the tacking motion and thereby ensuring that tacking is completed quickly and reliably for the reciprocal sweep.

In order to set the limited arc of rotation about the pitch axis, the blade may be mounted on a pivot which limits the arc of rotation. Alternatively, pitch stops may be provided in the blade as in FR3049988. However, preferably, the generator further comprising a pair of pitch stops external to the blade to set the limited arc of rotation about the pitch axis. Placing the stops outside of the blade, simplifies the structure. In particular there is no need for the base of the blade to be hollow to receive the stops, and the blade does not have to be thick enough to accommodate the stops and the degree of travel of the blade between the stops.

The position of the pitch stops may be fixed. Alternatively, the position of the pitch stops is adjustable to vary the pitch of the blade. The adjustment may be done prior to first use and then fixed during operation, for example, it there are several mounting locations for the pitch stops. Alternatively, the position of the pitch stops may be adjustable in use. This allows a dynamic operation. For example, a small pitch angle can be selected in a strong flow to limit power output and a large pitch angle can be selected in weak flow to increase the power output.

The generators can be mounted, either individually or in series, in relatively shallow water. For example, the generators may be mounted around offshore wind turbines. In this case they can share the power transmission network of the wind turbines. They can be mounted on the seabed, or on vessels which may be static either to generate power for the vessel or for larger scale power generation. This is discussed in greater detail below. They can be mounted with the blade uppermost or lowermost, the latter which would be particularly suitable for a mounting on a vessel. The generators can also function when mounted laterally such as onto the concrete base of a wind turbine.

The base may be mounted in a fixed position. This might be desirable if there is a well-defined flow direction. However, optionally, the base is mounted to be rotatable about a vertical axis offset upstream of the sweep axis. This allows the generator to automatically self-align with the flow direction and provides maximum efficiency in cases where the flow direction is not well-defined.

The tacking stops may be mounted to the generator such that the leading edge abuts the respective tacking stop. Alternatively the tacking stops may be provided by a tether which limits the movement of the leading edge.

The blade only needs to be overbalanced to a relatively small degree as the overbalance is only required in order to ensure that the blade is held open during the sweep. A larger overbalance would exaggerate this but would absorb more energy for the tacking operation.

As such, the pitch axis is preferably positioned such that greater than 50% and less than 60% or preferably greater than 50% and less than 55%, of the area of the blade is upstream/ahead of the pitch axis. The 50% end of the range represents being close to a balanced configuration, while increasing percentages represent increasing overbalance.

The generator generates power from the movement about the sweep axis. As such, a relatively large sweep angle is preferred. This is fundamentally different from the prior art devices which seek to vibrate the blade at low oscillations of around 5°. To achieve this, the blade is preferably rotatable through at least 50°, more preferably at least 60°, and most preferably at least 70° about the sweep axis.

The blade may have a uniform buoyancy. However, the blade preferably has differential buoyancy such that the region adjacent to the trailing edge has greater buoyancy than the region adjacent to the leading edge. During the tacking operation, the more buoyant trailing section will assist in rotating the blade to the opposite position.

The generator may also be fitted with a brake to lock the blade in a neutral or other position for maintenance. This can be achieved if adjustable tacking stops are provided as these can be moved into a position very close to the blade to prevent rotation of the blade about the pitch axis. Alternatively a remotely actuated lock may be provided.

Power is harnessed from the generator via the power output. The power output may, for example, be in the form of an electrical generator with a cable connection for onward transmission of the power.

Preferably, however, the power output is captured mechanically and in the form of a pumped fluid. This may be an incompressible fluid such as pumped water or a hydraulic fluid which may be biodegradable which can be pumped to a remote location for subsequent power conversion. More preferably, the power output is provided by compressed air. In this case, the generator is provided with a low pressure air inlet and a compressed air high pressure outlet and the power output is configured to drive a compressor which receives air from the low pressure air inlet, compresses it and pumps compressed air out through the high pressure compressed air outlet. The compressed air can then be fed to a compressed air engine coupled to an electrical generator. This has a number of benefits. The only connections required to the subsea generator are an ambient air inlet and a compressed air outlet. No electrical or hydraulic connections are required within a generator. As the compressed air is a benevolent gas, any leakage will not cause any pollution concerns. Further, the compressed air is relatively straightforward to store, for example, at an onshore location, or in a compressed air tank of a ship or re-configured oil and gas platform. Compressed air storage also allows for the smoothing of the power output as compressed air can be stored while the tidal current is running which can them be used for electrical generation between tides. This allows for a constant power output from a variable power source.

The generator is scalable to any practical size. Weight is not a critical issue as the blades are preferably configured with neutral or near neutral buoyancy to obviate gravitational effects at the end of each sweep. The weight will be a consequence of engineering and cost of manufacture calculations.

The blade may comprise a number of materials including steel, aluminium and composites with facility to adjust buoyancy of the blade to optimise performance and mechanical issues. The blade dimensions could be as much as 30 metres tall by 20 metres deep or more.

It is envisaged that a number of power generators of the invention will be mounted to the seabed in relatively close proximity to one another so that their power outputs would be connected together.

The blade preferably has a generally flat or hydrodynamically profiled paddle like configuration which preferably has longitudinal edges which are generally parallel to the pitch axis. This provides the maximum surface area and hence power output, for the given footprint. Further, the corners of the blade are preferably rounded off in order to reduce any snagging hazards.

A protective structure, such as a series of baffles or a cage may be provided around the generator in order to protect the blade from snagging or being damaged.

The generator may be mounted to the seabed. However, preferably the generator is mounted to a vessel with the blade extending downwardly from the vessel.

Mounting the generators in this way has a number of advantages. It significantly reduces the cost as compared to mounting the generators on the seabed which is costly and difficult to maintain. It is easier to extract the power at a location on a vessel, rather than at the seabed. There is no danger that the generators can be damaged by passing ships. The flows at the surface are often stronger than the flows deeper down offering the possibility of greater power extraction for the same geometry of blade.

The power generators are preferably attached to structures at the side of the vessel. This makes them more accessible for maintenance. To assist with the maintenance, preferably the vessel has a lifting mechanism which is configured to retrieve the power generators over the side of the vessel.

The generators may be rotatably mounted with respect to the vessel so that they can rotate to face the direction of flow. Preferably, however, the vessel is tethered such that it is free to rotate to face in the flow direction. This eliminates the need for a mechanism to pivot the generator.

Preferably when the generators are suspended from the vessel, the power is mechanically captured and transferred above sea level. The generation and process facilities can be provided on the vessel thus obviating any subsea power capture or electrical generation.

An example of a generator in accordance with the present invention will now be described with reference to the accompanying drawings, in which:

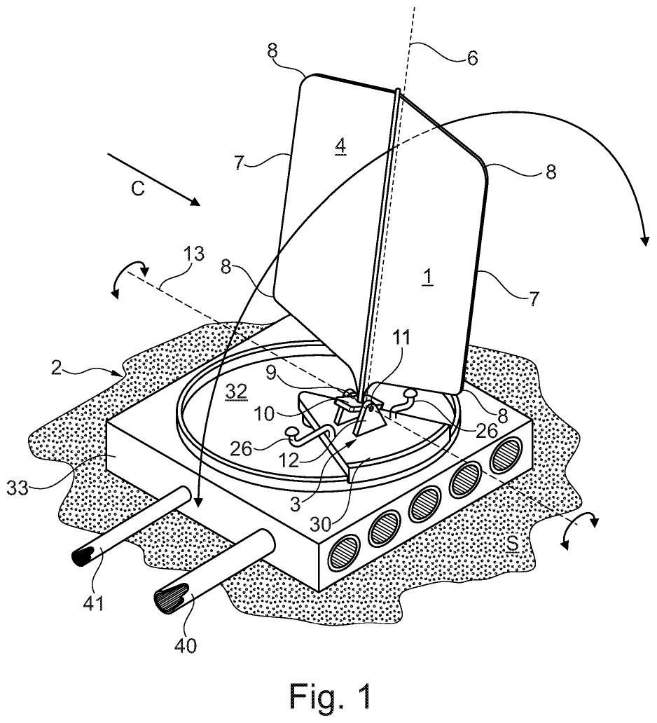

FIG. 1 is a schematic perspective of the generator mounted on the seabed;

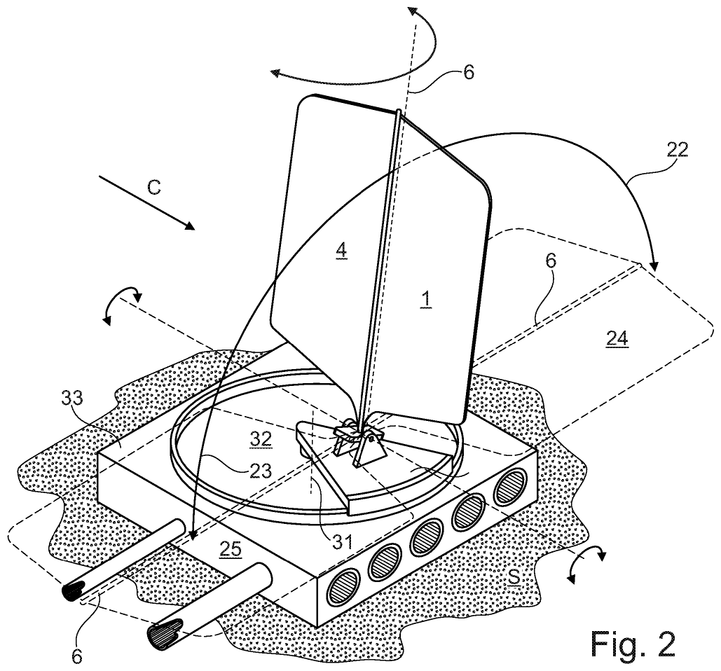

FIG. 2 is view similar to FIG. 1 showing the blade in central and end sweep positions;

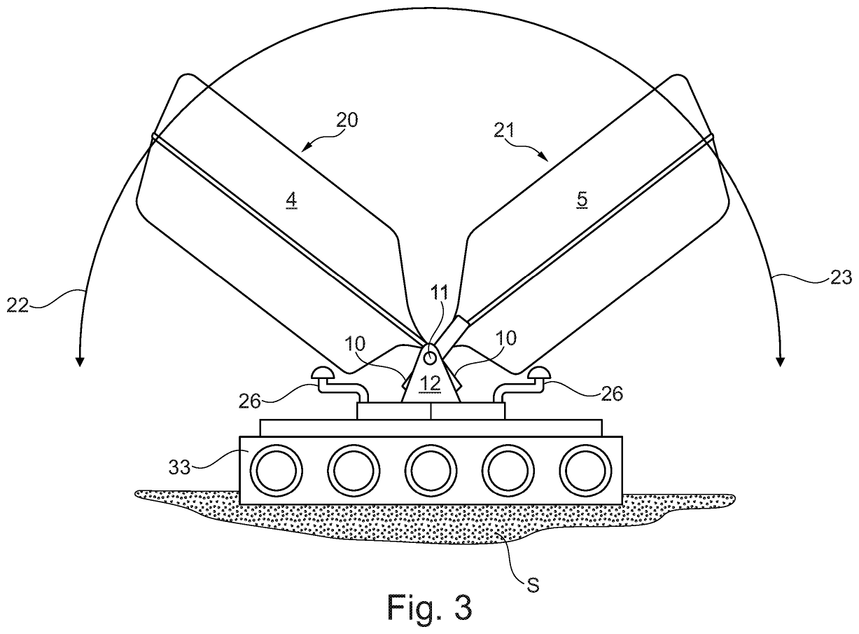

FIG. 3 is a side view of the generator showing the blade in intermediate positions;

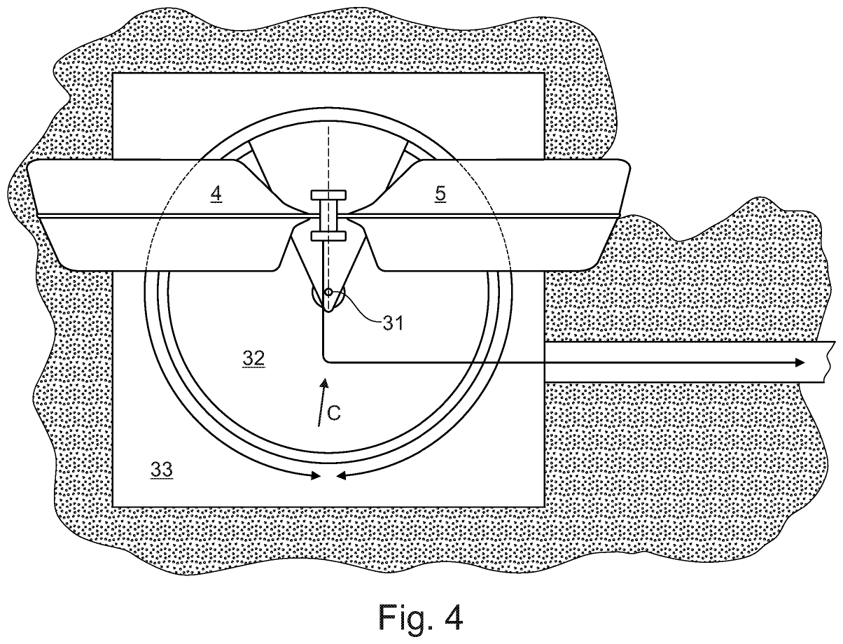

FIG. 4 is a plan view of the generator showing the blade in end sweep positions;

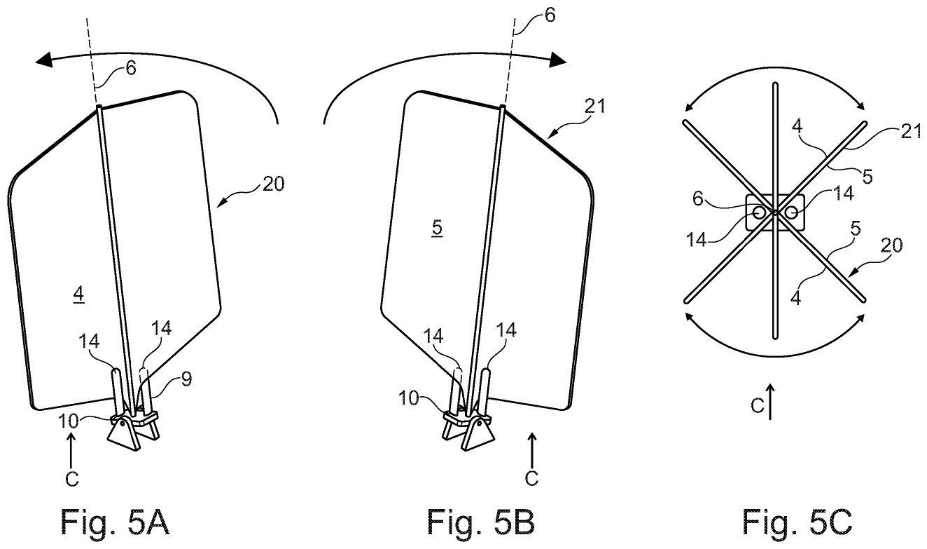

FIG. 5A is a perspective view of the blade in a first position;

FIG. 5B is a perspective view of the blade in a second position;

FIG. 5C is plan view of the blade showing its range of rotation about the pitch axis:

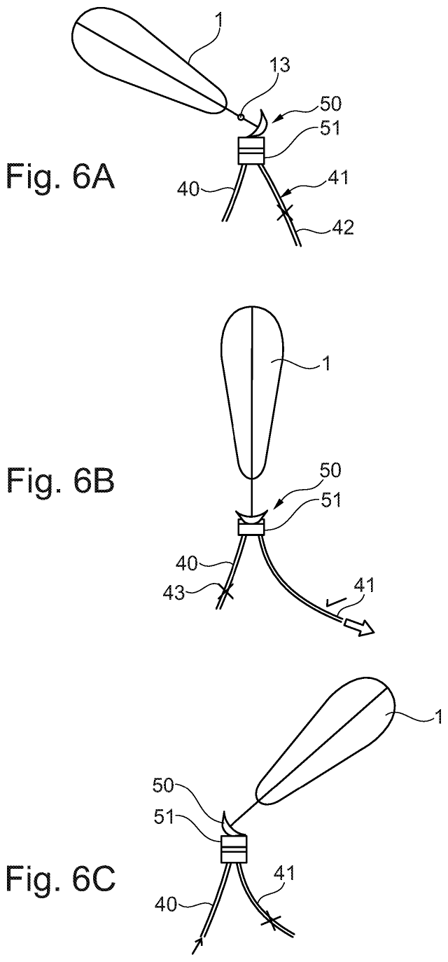

FIGS. 6A-C are schematic sketches showing a first power output mechanism;

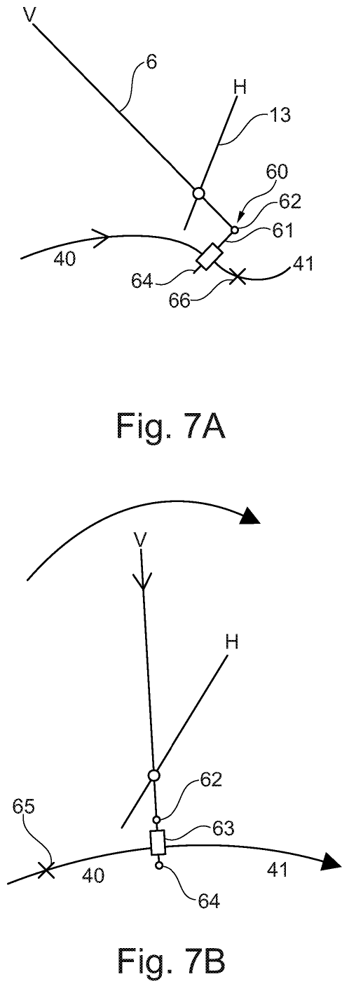

FIG. 7A and B are schematic sketches showing a second power output mechanism;

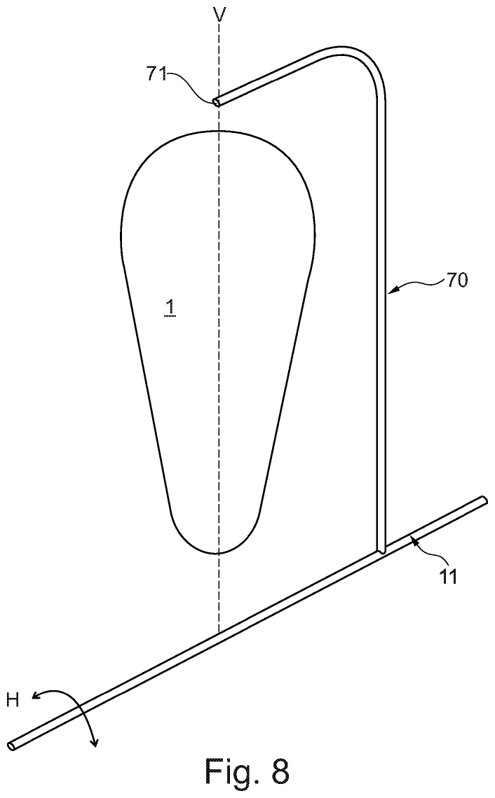

FIG. 8 is a schematic perspective view of an alternative blade support;

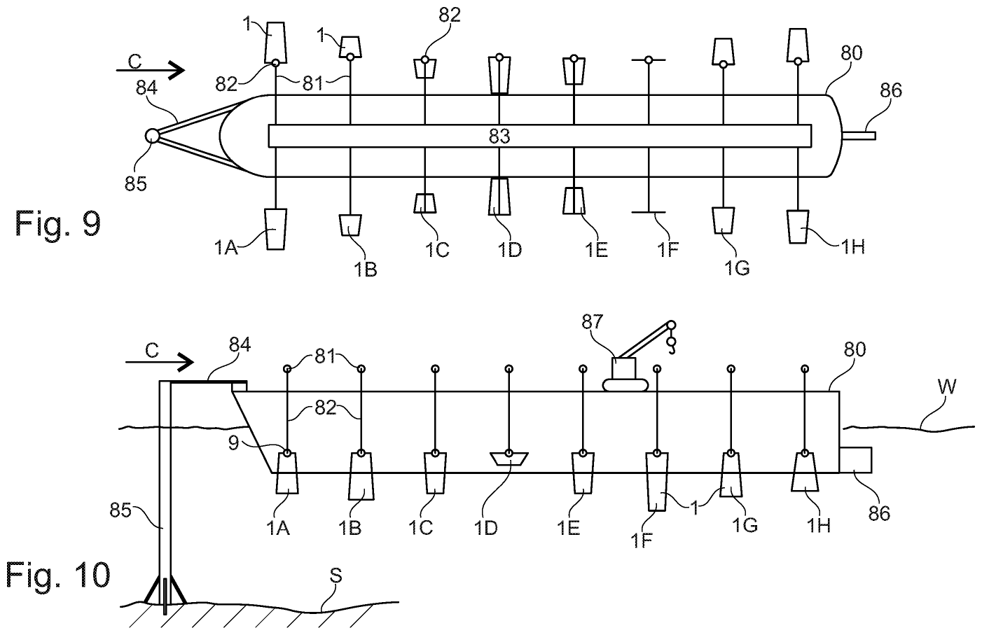

FIG. 9 is a schematic plan view of a vessel to which a number of generators are attached; and

FIG. 10 is a schematic side view of the vessel of FIG. 9.

The generator comprises a blade 1 and a base 2. The base is provided with a hinged connector 3 via which the blade 1 is connected to the base 2.

The blade 1 has a substantially flat or hydrodynamically profiled paddle like structure which is designed to have as large a surface area as possible in relation to the size of the base. The blade has a first face 4 on one side and a second face 5 on the opposite side and the pressure on these faces, when angled, will generate power from the flow as described below. The blade is mounted about a pitch axis 6 which extends generally centrally along the blade. This pitch axis 6 is positioned such that a greater proportion of the area of the blade is positioned on the upstream side of the pitch axis 6 in order to provide an overbalanced blade.

The blade 1 is mounted into the hinged connector via a rotary connection 9 in the form of a stub extending from a mounting plate 10 over which the hollow blade stem is mounted to rotate about the pitch axis 6.

The pitch of the blade 1 (i.e. the extent which it can rotate about the pitch axis 6) is limited by pitch stops 14 mounted to plate 10 as shown in FIGS. 5A to 5C. These will be present in the remaining drawings but have been omitted for clarity. Alternative methods exist, for example, within the hinging to control and optimise pitching of the blade. This limited range of movement is best shown in FIG. 5C and indicated by the arrow in FIG. 2. This is an arc of approximately 90°, 45° either side of the centre line. The degree to which the blade 1 is rotatable about the pitch axis 6 may be varied and can be optimised for the localised conditions either during operation, or by adjusting the position of the pitch stops 14 during a set up operation.

The lateral edges 7 of the blade 1 may run generally parallel to the pitch axis 6 in order to maximise the area of the blade for the given footprint. The corners 8 of the blade are rounded in order to reduce the snagging hazard.

The mounting plate 10 is pivotally connected via an axle 11 to a pair of supports 12. This allows the blade to pivot about a sweep axis 13 potentially via an arc of up to 180° of movement as illustrated in FIGS. 1 and 2.

The sweep axis 13 is generally horizontal. However, in practice, this may not be precisely horizontal, particularly if mounted on an inclined surface. The pitch axis 6 is generally vertical in the upright position shown in FIGS. 1 and 2 and will reciprocate in a vertical plane as described in greater detail below.

As shown in the drawings, the pitch axis 6 intersects with the sweep axis 13. This provides the most efficient motion of the blade. However, these axes may be offset to some extent and still function, albeit less efficiently.

The motion of the blade 1 will now be described. In the drawings, the direction of the flow is indicated as the current C with an arrow as shown in most drawings. In FIG. 3, the direction of the current is into the page.

The blade 1 is shown in a vertical neutral position in FIGS. 1 and 2 and is rotatable about the pitch axis 6 between a first rotary position 20 as shown in FIGS. 3, 5A and 5C in which the first face 4 faces the current C and a second rotary position 21 shown in FIGS. 3, 5B and 5C in which the second face 5 faces the current C.

In the first rotary position 20, the pressure on the first face 4 has caused the blade 1 to rotate about the sweep axis 13 in the anti-clockwise direction 22 (as shown in FIG. 3).

When the blade 1 tacks to the second rotary position 21, pressure on the second face 5 causes the blade 1 to rotate about the sweep axis 13 in the clockwise direction 23 (as shown in FIG. 2).

The blade 1 is effectively held in each rotary position 20,21 by the pressure locating the blade against the pitch stops 14. The end points 24, 25 of the motion of the blade 1 about the axle 11 are depicted in FIG. 2.

As the blade 1 begins to reach an end point 24,25 its leading edge contacts one of two tacking stops 26 mounted to a base plate 30. At this point, the momentum of the leading edge is arrested, while the momentum of the blade as a whole causes the rest of the blade to continue moving such that it rotates around the pitch axis 6 back towards a neutral position beyond which position, the main flow contacts the opposite side of the blade. The pressure will be sufficient to move the blade through the neutral point thereby tacking the blade rotating it towards the second position 21. If the blade is balanced, a mechanical actuator may be provided in order to push the blade through this neutral position.

The blade 1 will then move back in the opposite direction about the sweep axis 13 until it reaches the opposite end point where it will again tack in the same member.

As a result of all of this, the relatively slow, but relatively high-power reciprocating rotation is generated about the sweep axis 13. This motion is coupled to an energy convertor

As shown in the drawings, the hinged connector 3 is mounted on base plate 30 which is rotatable about a substantially vertical axis 31 offset upstream from the pitch axis 6 such that the base plate 30 can rotate about a circular base 32. The offset nature of the axes 6, 31 allows the generator to self-align with the direction of the current C either because the direction fluctuates over time by small increments, or because the generator is mounted in a tidal flow where the flow will change through approximately 180° with the turning of the tide.

The base is provided with an anchor plate 33 which has a large mass and/or is anchored by other means to the seabed S. The anchor plate 33 is provided with an ambient air inlet 40 and a compressed air outlet 41. Air is drawn in through the air inlet 40, compressed by the compressor and is output through the compressed air outlet 41 which is fed to a generator, suitable storage tanks or onshore or platform based storage facility.

An array of generators may positioned in close proximity on the seabed S and suitably linked manifolds may be provided in order to feed the ambient air and retrieve the compressed air from the entire array.

An example of a compressor 51 is schematically illustrated in FIGS. 6A to 6C. Here, the blade 1 is shown rotating about the sweep axis 13. A cam 50 is provided on the opposite side of the sweep axis 13 from the blade 1. As the blade rotates, the cam 50 engages with the compressor 51 which is either formed as a collapsible bellows construction or is in the form of a cylinder and piston. Starting from FIG. 6A, with the blade at an end point 24, the air inlet 40 is open and a compressed air outlet is closed by outlet valve 42. In this position, air can enter the compressor 50. As the blade 1 moves to the right in FIG. 6A, the cam 51 begins to compress the compressor 50. In the initial part of the stroke, the inlet valve 43 and air outlet valve 42 are both closed such that the air in the compressor 50 is compressed. The compressed air outlet valve 42 then opens as shown in FIG. 6B thereby expelling compressed air along compressed air outlet 41. As the blade 1 moves towards the end position shown in FIG. 6C, the compressed air outlet valve 42 is closed and the air inlet 40 is opened causing air to be sucked in through the air inlet into the expanding compressor 51 whereupon the process described above in relation to FIG. 6A is repeated with the blade 1 travelling in the opposite direction.

A second example of a compressor arrangement is shown schematically in FIGS. 7A and 7B. In this example, the pitch 6 and sweep 13 axes are depicted schematically. An end 60 of the blade 1 which is on the opposite side of the sweep axis 13 will follow a reciprocating arcuate path. This end 60 is coupled to a piston rod 61 via a rotary connection 62. Piston 63 is mounted such that its opposite end is rotatable about a pivot point 64. As the blade rotates, the above described connection provides a crank-like coupling which causes the piston rod 61 to reciprocate within the piston 63. The piston 63 is connected to the air inlet 41 and air outlet 42. The corresponding air inlet 65 and air outlet 66 valves which are opened and closed as described above in order to allow air into the piston 63 on the expansion stroke and for compressed air to be expelled in the latter part of the compression stroke.

An alternative way of mounting the blade 1 is shown in FIG. 8. In this case, a support bar 70 is attached to the axle 11 and extends up beyond the blade 1 to provide additional support 21 at the top end of the blade 1. The support bar 70 can also be provided with the pitch stops 14 in order to limit the pitch of the blade 1. In addition, this arrangement provides a more stable support for the blade as it is supported at both ends of the pitch axis. Further, the support arm 70 may provide a degree of protection for the blade as it is able to deflect debris up and over the blade 1.

FIGS. 9 and 10 show a plurality of generators attached to a vessel 80. Each generator is mounted on a gantry shown schematically as an outwardly extending arm 81 connected to a downward extending arm 82. In practice this will be a scaffold like structure. At the end of the gantry a blade 1 is connected by rotary connection 9 such that it is suspended below the waterline W.

The motion of the blades is as previously described. In FIGS. 9 and 10, blades 1 are shown schematically in different phases of their motion as follows: 1A fully outwardly extended, 1B starting to sweep in, 1C sweeping in past vertical, 1D fully inwardly extended, 1E starting to sweep out, 1F vertical, 1G sweeping out, 1H fully outwardly extended.

Although a single row is shown on each side multiple rows may be used in practice. These may be aligned with or offset from the illustrated blades.

Power from each blade is transmitted to generating equipment 83 as previously described.

The vessel has a tether 84 attached to a post 84 attached to the seabed S and the vessel has a rudder 86 so that the vessel can be oriented to face the current C. A crane 87 is provided on the vessel so that the blades 1 can be retrieved for maintenance/replacement.

1. A power generator for generating power from a water flow flowing in a flow direction, the generator comprising:
a single blade with first and second faces on opposite sides of the blade;
a base to which the blade is rotatably mounted;
the blade being mounted so as to be reciprocally rotatable through a limited arc about a sweep axis, the sweep axis extending in the flow direction;
the blade further being mounted to be rotatable through a limited arc about a pitch axis, the pitch axis being transverse to the sweep axis and extending along a mid-portion of the blade such the blade is overbalanced respect to the flow direction, and so as to be selectively retainable in a first rotary position in which its first face faces the flow, and a second rotary position in which its second face faces the flow;
wherein when the blade is in the first rotary position, in use, the flow can push the blade in a first direction about the sweep axis, when the blade reaches the limit of its rotation in the first direction, it is configured to tack about the pitch axis so that the blade is in the second rotary position in which the flow can push the blade back in a second opposite direction about the sweep axis, and when the blade reaches the limit of its rotation in the second direction about the sweep axis, it is configured to tack about the pitch axis so that the blade is back in the first rotary position;
the generator further comprising a power output coupled to receive power from the blade reciprocating about the sweep axis;
wherein a respective passive tacking stop is provided to arrest the momentum of the leading edge of the blade and cause the blade to tack when the blade reaches the limit of its rotation in the respective first and second directions.

2. The power generator according to claim 1, wherein each passive tacking stop is positioned to engage with part of the blade which is closer to the leading edge than to the pitch axis.

3. The power generator according to claim 1, further comprising a pair of pitch stops external to the blade to set the limited arc of rotation about the pitch axis.

4. The power generator according to claim 3, wherein the position of the pitch stops is adjustable to vary the pitch of the blade.

5. The power generator according to claim 1, wherein the pitch axis is positioned such that greater than 50% and less than 60% of the area of the blade is upstream of the pitch axis.

6. The power generator according to claim 1, wherein the pitch axis is positioned such that greater than 50% and less than 55% of the area of the blade is upstream of the pitch axis.

7. The power generator according to claim 1, wherein the blade is rotatable through at least 50°, preferably at least 60°, and more preferably at least 70° about the sweep axis.

8. The power generator according to claim 1, preceding claim, wherein the blade has differential buoyancy such that the region adjacent to the trailing edge has greater buoyancy than the region adjacent to the leading edge.

9. The power generator according to claim 1, wherein the power output is in the form of a pumped fluid.

10. The power generator according to claim 9, wherein the power output is provided by compressed air.

11. The power generator according to claim 10, wherein the generator is provided with a low pressure air inlet and a compressed air outlet and the power output is configured to drive a compressor which receives air, in use, from the low pressure air inlet, compresses it and pumps compressed air out through the compressed air outlet.

12. The power generator according to claim 1, wherein the blade has a generally flat paddle like configuration.

13. The power generator according to claim 1, wherein the blade has longitudinal edges which are generally parallel to the sweep axis.

14. The power generator according to claim 1, wherein the corners of the blade are rounded off in order to reduce any snagging hazards.

15. The power generator according to claim 1, wherein a protective structure, is provided around the generator.

16. A floating vessel comprising at least one power generator according to claim 1 mounted to the vessel with the blade extending downwardly from the vessel.

17. The floating vessel according to claim 16, wherein the power generators are attached to structures at the side of the vessel.

18. The floating vessel according to claim 16, wherein vessel has a lifting mechanism which is configured to retrieve the power generators over the side of the vessel.

19. The floating vessel according to claim 16, wherein the vessel is tethered such that it is free to rotate to face in the flow direction.
